(19) United States
(12) Patent Application Publication
(10) Pub. No.: US 2010/0086775 A1
(43) Pub. Date: Apr. 8, 2010

(54) OPTICAL SPECTRALLY SELECTIVE COATINGS

(76) Inventors: Bruce Lairson, Friday Harbor, WA (US); Norman L. Boling, Santa Rosa, CA (US); Paul Morand, Rohnert Park, CA (US)

Correspondence Address: DUANE MORRIS LLP - DC, 505 9th Street, Suite 1000, WASHINGTON, DC, 20004-2166, US

(21) Appl. No.: 12/572,627

(22) Filed: Oct. 2, 2009

Related U.S. Application Data
(60) Provisional application No. 61/136,818, filed on Oct. 6, 2008.

(51) Int. Cl. B32B 15/04; B05D 3/10

(52) U.S. Cl. 428/336; 428/457; 427/343

(57) ABSTRACT

A multilayer reflective coating and devices employing such coatings, the coating comprising layers of aluminum and silver and a barrier layer disposed between the aluminum and silver layers. The barrier layer may be substantially optically transparent and formed from material that substantially inhibits interdiffusion between the aluminum and silver layers. The coating may also include capping layer disposed over the silver layer. The barrier layer may be formed from nitrides, oxides and oxynitrides.

### RELATED APPLICATIONS

The instant application is co-pending with and claims the priority benefit of U.S. Provisional Patent Application No. 61/136,818 filed Oct. 6, 2008, entitled “Multilayer Coating and Method,” the entirety of which is incorporated herein by reference.

### BACKGROUND

Embodiments of the present subject matter generally relate to broadband, highly reflective layers and coatings for various applications, such as, but not limited to, multi-junction solar cells, solar collectors, solar concentrator systems, lighting reflectors, and various reflective mirrors. Generally, aluminum and silver are utilized to obtain high reflectivity in reflective mirrors and lighting applications. Aluminum may be preferred due to its low cost, durability, and adequate reflectivity in the blue region of the electromagnetic spectrum. Silver may be preferred due to its high visible light reflectivity, though this reflectivity is less in the blue and ultraviolet regions of the electromagnetic spectrum.

Curved reflectors for lighting applications generally require a high reflectivity to provide acceptable lighting efficiencies, and recent changes in the costs of energy have placed a premium on high performance reflectors. Examples of typical reflectors may be, but are not limited to, parabolic aluminized reflectors (“PAR”), bulged reflectors, elliptical reflectors, blown parabolic reflectors, and other curved, planar or parabolic reflector designs. A recent area of emphasis in reflector lamp design has been to increase energy efficiency. Energy efficiency is typically measured in the lighting industry by reference to the lumens produced by the lamp per watt of electricity input to the lamp (“LPW”). A lamp having a high LPW is more efficient than a comparative lamp demonstrating a low LPW. Several methods exist in which the LPW of lamps may be increased, e.g, through structural design, coatings, etc. One of the more commonly employed reflector coatings is an aluminum film, which may generally be deposited on the surface of a reflector by thermal evaporation or sputtering. Manufacturing costs are low and the aluminum film is stable at lamp operating temperatures over the life of the lamp. Reflectivities of typical aluminum films in the visible spectrum are such that approximately 70% of the light emitted from the lamp filament tube may be converted to luminous output. Silver films, however, provide a higher reflectivity and are generally able to convert about 80-85% of the light emitted from the lamp filament tube to luminous output. Silver films may be prepared in a similar manner to the aluminum films; however, evaporated or sputtered silver films may be unstable at temperatures in excess of 200° C., and unprotected silver films exhibit poor oxidation and chemical resistance.

One known coating that enhances the reflectivity of silver is generally termed as an “enhanced silver” coating or layer. An enhanced silver layer is an optically thick silver layer onto which one or more dielectric layers are deposited to improve reflectivity in the blue region, around 450 nm. Typically, around 50 nm of SiO₂ and 40 nm of TiO₂ may increase reflectivity at 450 nm from about 90% to above 95%. Enhanced silver generally requires a silver layer that is more than 100 nm thick to provide sufficient optical density. U.S. Pat. Nos. 6,773,141 and 6,382,816 to Zhao, et al. describe a high reflectivity protected silver layer having a thickness between 100 nm and 600 nm. The thickness of the silver layer in Zhao, however, may be cost prohibitive in many applications.

Protective coatings on silver films are also known for mirrors in optical and lighting applications. For example, U.S. Pat. No. 7,513,815 to Israel, et al. describes methods of producing a protective coating for silver films, the coating including silica and maintaining acceptable light temperatures and colors. U.S. Pat. No. 6,078,425 to Wolfe, et al. describes a durable silver coating for mirrors having a broadband reflectivity from about 200 nm to 10,000 nm. Wolfe provides a mechanically durable overcoat onto a thin silver layer which allows reflection of an aluminum sub-layer below 400 nm and allows sufficient reflectivity from the silver at 850 nm to mask the 850 nm dip resultant from aluminum. An adhesion layer is placed between the silver and aluminum, comprised of chromium, nickel, or their nitrides. Wolfe teaches a protective layer over the silver layer to enhance mechanical durability; however, this protective layer fails to inhibit silver agglomeration or provide higher reflectivity at shorter wavelengths. Further, Wolfe fails to address interdiffusion between the adjacent aluminum and silver layers as the adhesion layer is provided for adhesive purposes.

For lighting applications, e.g., halogen lighting, it may be desirable to increase blue reflectivity to thereby increase color temperature of the light source. Halogen light sources typically contain less blue output, and thus a lower color temperature, than other light sources such as arc sources and broadband light emitting diodes. Consumers, however, often regard low color temperature as having a lower quality. It may also be desirable to provide an economical coating resulting in a color temperature of greater than 2800° C. with an average visible reflectance of >90% from a halogen light source.

For solar energy applications, considerable research and development have been conducted recently in concentrated solar energy systems. One exemplary system may be a photovoltaic system having modules with concentrating optical components. One objective of a concentrator system is to improve solar cell or photovoltaic performance by increasing the solar intensity falling on the cell. Another objective of a concentrator system is to reduce the cost of the kW peak by reducing the area of the solar cells being used in the system. These concentrated solar energy collection systems typically require reflecting large parts of the electromagnetic spectrum. The electromagnetic spectrum at ground level contains significant energy in the range from 350 mm to about 2500 nm. Increases in reflectivity in this region of the spectrum may increase the overall efficiency of an exemplary solar power system. Further, due to the available types of semiconductor materials, there may also be a particular need for high reflectivity in the short wavelength region of this range, from about 350 nm to about 450 nm. If insufficient light is available in this wavelength range, the semiconductor junction responsible for converting this light may become reverse biased and limit the power output of other junctions depending upon the structure of the cell. Thus, a mechanism is needed in the art to enhance the performance of multi-junction solar cell structures and to provide a high efficiency, low-cost reflective coating providing a high reflectivity over the range of 400 nm to 700 nm for lighting applications, and over the range 350 nm to 1500 nm for concentrated solar energy collection systems.

Another exemplary solar concentrator system is commonly referred to as a concentrated solar power plant. Concentrated solar power plants generally employ parabolic, planar or curved troughs using thousands of mirrors that concentrate solar radiation onto thermos tubes placed at the focal axis of the troughs and containing heat transfer fluid or that concentrate solar radiation onto a specially designed tower containing a heat transfer fluid. Each of these embodiments operate using the same principle where the heat transfer fluid is heated by the concentrated solar radiation and this heat is exchanged with water producing steam that drives a conventional turbine. These concentrated solar energy collection systems also typically require reflecting large parts of the electromagnetic spectrum. Thus, a mechanism is needed in the art to enhance the performance of concentrated solar power plants and to provide a high efficiency, low-cost reflective coating for the reflective surfaces employed therein.

Embodiments of the present subject matter address issues of thermal durability and enhanced reflectivity in the range from 350 nm to 1500 nm. In certain embodiments, reflectivity may be increased in the wavelength range between 350 nm and 450 nm to a higher value than is typically obtained with either aluminum (<92%) or silver (<92%). Embodiments of the present subject matter may include a barrier layer between aluminum and silver layers which is substantially optically transparent material and acts as a diffusion barrier between the aluminum and silver layers. Exemplary barrier layers may also be a substantially continuous layer having an absorption of less than about 2%. Furthermore, embodiments of the present subject matter may utilize less silver than typical applications and achieve higher reflectivity in the blue wavelengths of the electromagnetic spectrum.

One embodiment of the present subject matter provides a multilayer reflective coating is provided which comprises layers of aluminum and silver and a barrier layer disposed between the aluminum and silver layers. The barrier layer may be formed from material that substantially inhibits interdiffusion between the aluminum and silver layers.

Another embodiment of the present subject matter provides an apparatus having a substrate and a multilayer coating on the substrate. The coating may include layers of aluminum and silver separated by a barrier layer formed from a material that substantially inhibits interdiffusion of the aluminum and silver.

A further embodiment of the present subject matter provides a reflector having a substrate and a multilayer coating on the substrate. The coating may include layers of aluminum and silver wherein the silver layer is formed on a surface of the substrate.

One embodiment may provide a multilayer reflective coating consisting of layers of aluminum and silver. Another embodiment may provide a multilayer reflective coating consisting of layers of aluminum and silver and a capping layer disposed over the silver layer. An additional embodiment may provide a method of producing a multilayer reflective coating comprising depositing a layer of aluminum onto a substrate, oxidizing or nitriding the deposited layer of aluminum, depositing a layer of silver over the oxidized or nitrided layer of aluminum, and depositing a capping layer over the deposited layer of silver. A further embodiment may provide a method of producing a multilayer reflective coating comprising depositing a layer of aluminum onto a substrate, depositing a barrier layer over the deposited layer of aluminum, and depositing a layer of silver over the barrier layer where the barrier layer is formed from material that substantially inhibits interdiffusion between the aluminum and silver layers.

An additional embodiment of the present subject matter may provide a multilayer reflective coating having layers of aluminum and silver and a layer disposed between the aluminum and silver layers. The layer between the aluminum and silver layers may not comprise nickel or chromium.

One embodiment of the present subject matter may provide a reflector comprising a substrate having a surface and a multilayer coating formed on at least a portion of the substrate surface. The coating may include a layer of aluminum overlying at least a portion of the substrate surface, where the aluminum layer has a substantially uniform thickness between 5 nm and 500 nm. The coating may also include a barrier layer overlying at least a portion of the aluminum layer, where the barrier layer has a substantially uniform thickness less than 30 nm. The coating may further include a layer of silver overlying at least a portion of the barrier layer, where the silver layer has a substantially uniform thickness between 5 nm and 120 nm. The coating may include a capping layer overlying at least a portion of the silver layer, where the capping layer having a substantially uniform thickness greater than 1 nm.

Another embodiment may provide a reflector comprising a substrate and a multilayer coating on the substrate. The coating may include layers of aluminum and silver where the silver layer is formed closer to the surface of the substrate than the aluminum layer.

One embodiment may provide a lamp comprising a housing, a socket positioned in the housing, where the socket is adapted to operatively and removeably receive a light source, and a reflector supported from the housing. The reflector may be positioned to encompass the light source operatively received in the socket. The lamp may also include a reflective surface covering a portion of a surface of the reflector facing the light source, where the reflective surface comprises a multilayer coating having layers of aluminum and silver separated by a barrier layer formed from a material that substantially inhibits interdiffusion of the aluminum and silver.

Another embodiment may provide a lamp comprising a housing, a light source within the housing, a reflective surface covering a portion of an interior surface of the housing. The reflective surface may include a multilayer coating having layers of aluminum and silver separated by a barrier layer formed from a material that substantially inhibits interdiffusion of the aluminum and silver.

Another embodiment of the present subject matter may provide an apparatus comprising a substrate having a surface and a multilayer reflective coating formed on at least a portion of the substrate surface. The coating may comprise a layer of aluminum and a layer of silver separated by a barrier layer formed from one or more materials selected from the group consisting of: aluminum nitride, silicon nitride, aluminum oxynitride, silicon oxynitride, aluminum silicon nitride, aluminum silicon oxynitride, and titanium dioxide.

These embodiments and many other objects and advantages thereof will be readily apparent to one skilled in the art to which the invention pertains from a perusal of the claims, the appended drawings, and the following detailed description of the embodiments.

### BRIEF DESCRIPTION OF THE DRAWINGS

FIGS. 1A-1D are cross-sectional diagrams of embodiments of the present subject matter.

FIG. 2 is a graphical representation of reflectivity versus wavelength for various barrier layers.

FIG. 3 is a graphical representation of reflectivity versus wavelength before and after a 30 minute bake at 300° C. for one coating.

FIG. 4 is a graphical representation of reflectivity versus wavelength for another embodiment of the present subject matter.

FIG. 5 is a graphical representation of reflectivity versus wavelength for a further embodiment of the present subject matter.

FIG. 6 is a graphical representation of reflectivity versus wavelength for one embodiment of the present subject matter.

FIG. 7 is a graphical representation of reflectivity versus wavelength for a further embodiment of the present subject matter.

FIG. 8 is a graphical representation of reflectivity versus wavelength for an additional embodiment of the present subject matter.

FIG. 9 is a graphical representation of reflectivity versus wavelength for bare aluminum deposited at different powers.

FIG. 10 is a graphical representation of reflectivity versus wavelength for one embodiment of the present subject matter.

FIG. 11 is a graphical representation of a comparison of one embodiment of the present subject matter and a conventional enhanced silver coating.

FIG. 12 is a graphical representation of reflectivity versus wavelength for yet another embodiment of the present subject matter.

FIG. 13 is a simulated result illustrating an optical performance of enhanced aluminum, enhanced silver, and one embodiment of the present subject matter.

FIG. 14 is a simulated result illustrating an optical performance for enhanced silver optimized for lighting compared to an embodiment of the present subject matter.

FIG. 15 is a perspective view of a conventional magnetron sputtering system.

FIG. 16 is a perspective view of another magnetron sputtering system.

FIG. 17 is a perspective view of a sputtering systems having tooling allowing more than one degree of rotational freedom.

FIG. 18 is a perspective view of a reflector according to an embodiment of the present subject matter.

FIG. 19 is a perspective view of a lamp according to an embodiment of the present subject matter.

FIG. 20 is a perspective cut-away view of another lamp according to an embodiment of the present subject matter.

FIG. 21 is a perspective view of a C-module.

FIG. 22 is a cross-sectional diagram of a C-module.

FIG. 23 is an exploded diagram of an exemplary secondary concentrator.

### DETAILED DESCRIPTION OF THE DRAWINGS

With reference to the figures where like elements have been given like numerical designations to facilitate an understanding of the present subject matter, the various embodiments of optical spectrally selective coatings and methods are herein described.

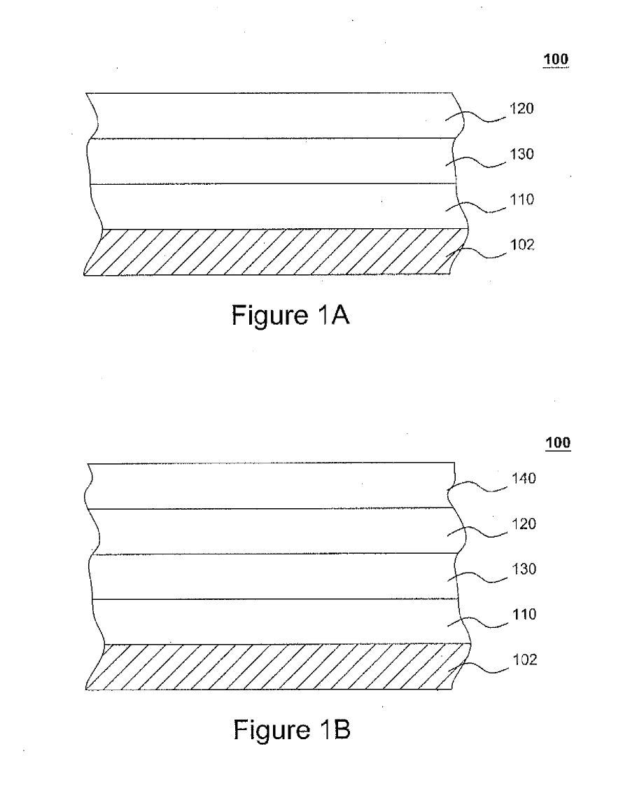

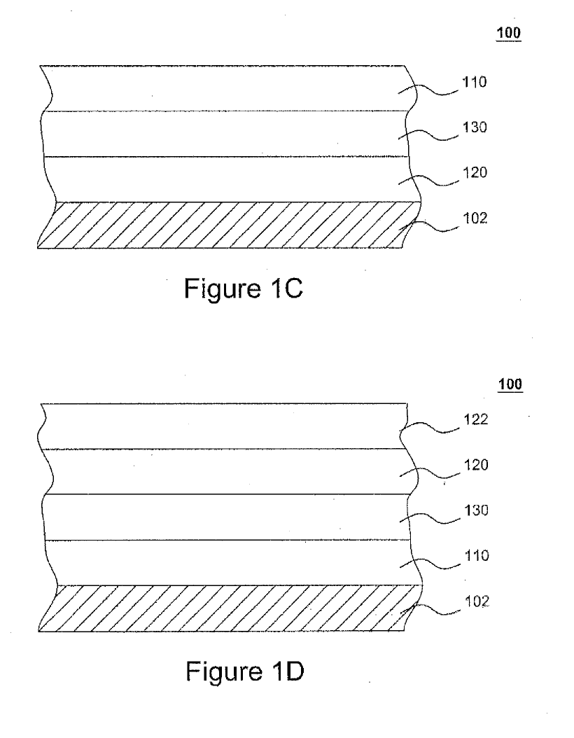

Embodiments of the present subject matter may provide a high efficiency, low cost, reflector stack having a high reflectivity. Generally, the stack may include a thin layer of aluminum, a thin layer of silver, and a thin barrier layer between the silver and aluminum layers. FIG. 1A is a cross-sectional diagram of one embodiment of the present subject matter. With reference to FIG. 1A, one embodiment of the present subject matter provides a multilayer reflective coating 100 disposed on a substrate 102. The coating 100 may include a layer of aluminum 110 and a layer of silver 120 having a barrier layer 130 disposed between the aluminum and silver layers. The thickness of the aluminum layer 110 may be between 5 nm and 500 nm. In one embodiment, the thickness of the aluminum layer 110 may be less than 100 nm. In another embodiment, the thickness of the silver layer 120 may be between 5 nm and 100 nm. The barrier layer 130 may be formed from material that substantially inhibits interdiffusion between the aluminum and silver layers. The barrier layer 130 may be substantially optically transparent and, in one embodiment, may have a thickness of less than 30 nm. In another embodiment, the barrier layer 130 may be comprised of materials other than nickel or chromium. The thickness of the coating 100 may be less than 200 nm. Further, in one embodiment, a multilayer reflective coating may consist of only the layers of aluminum 110 and silver 120.

FIG. 1B is a cross-sectional diagram of another embodiment of the present subject matter. With reference to FIG. 1B, a multilayer reflective coating 100 may also include a capping layer 140 disposed over the silver layer 120. In one embodiment, the thickness of the coating 100 having a capping layer 140 may be less than 300 nm. While not shown, a dielectric coating may also be provided overlying portions of the capping layer 140. Relative to previous coatings known in the art, the present coating 100 employs less silver and provides a higher blue reflectivity and durability, among other advantages. For example, compared to conventional enhanced silver coatings that require silver coatings of more than 100 nm, a coating 100 according to one embodiment of the present subject matter may achieve a high reflectivity with a thickness of the silver layer less than 100 nm, e.g., 80 nm. Further, embodiments of the present subject matter also provide a much higher reflectivity in the ultraviolet region of the electromagnetic spectrum in comparison to conventional enhanced silver coatings. Further, in one embodiment, the multilayer reflective coating may consisting of only layers of aluminum 110 and silver 120 and a capping layer 140 disposed over the silver layer 120.

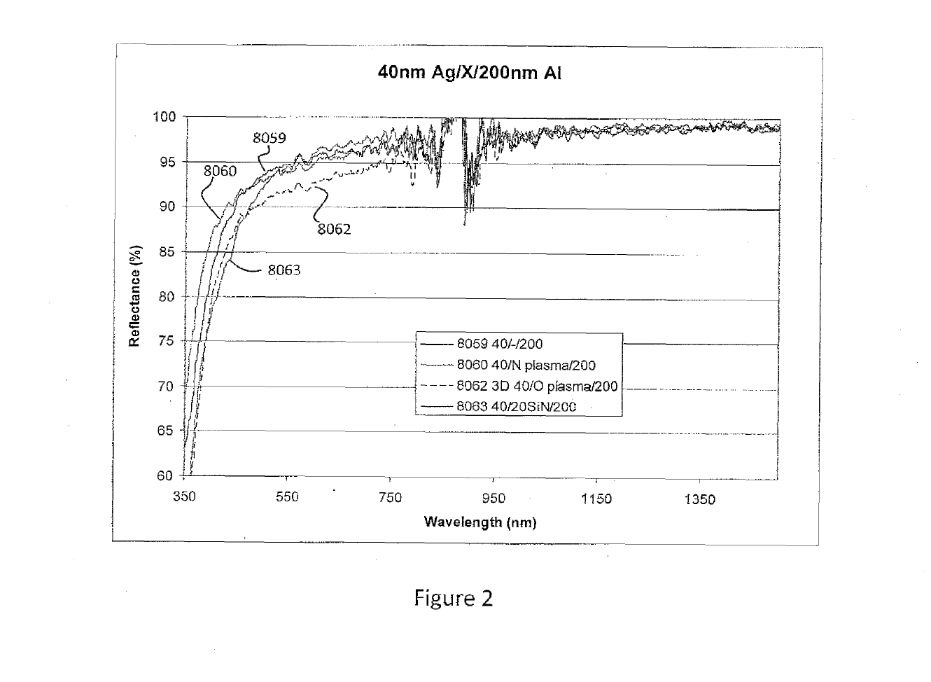

Exemplary barrier layers according to embodiments of the present subject matter prevent interdiffusion between the aluminum and silver layers. Thus, conventional coatings without exemplary barrier layers experience interdiffusion between the silver and aluminum over time resulting in a lower reflectivity. FIG. 2 is a graphical representation of reflectivity versus wavelength for various barrier layers produced either by reacting the aluminum surface with a plasma or depositing a distinct layer of 20 nm SiN. With reference to FIG. 2, four coatings were formed. A first coating 8059 comprised only a 40 nm layer of silver overlying a 200 nm layer of aluminum. A second coating 8060 comprised a 40 nm layer of silver overlying a 200 nm layer of aluminum having a surface reacted with a nitrogen plasma. A third coating 8062 comprised a 40 nm layer of silver overlying a 200 nm layer of aluminum having a surface reacted with an oxygen plasma. A fourth coating 8063 comprised a 40 nm layer of silver, a 200 nm layer of aluminum and a 20 nm barrier layer comprised of SiN between the aluminum and silver layers. Each coating was baked for approximately 30 minutes at 300° C. As is readily observable, the coating 8059 without a barrier layer observed significant interdiffusion between the silver and aluminum layers resulting in a lower reflectivity. The coating 8063 having a 20 nm SiN barrier layer, however, exhibited an increased reflectivity relative to silver at wavelengths below 400 nm.

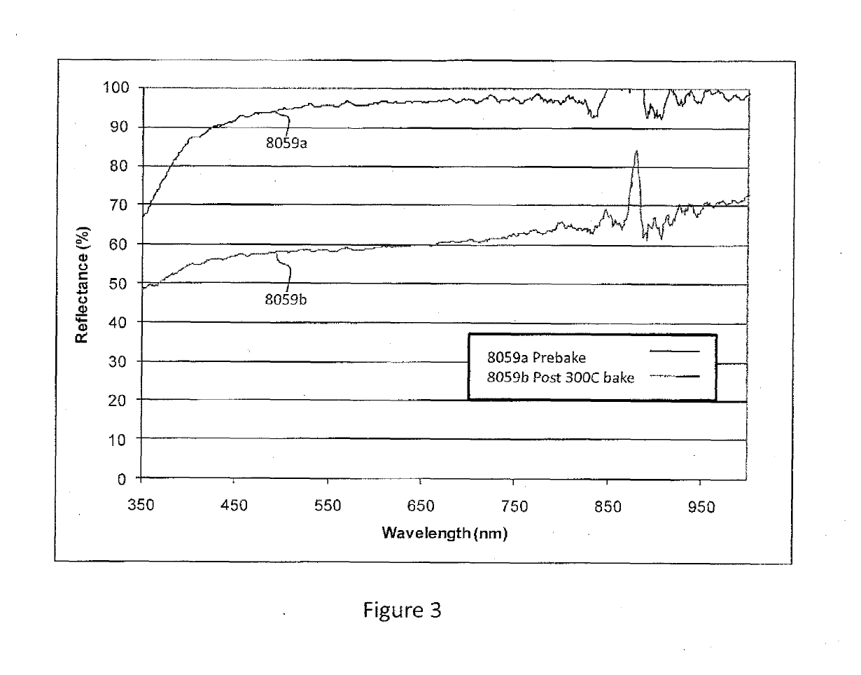

FIG. 3 is a graphical representation of reflectivity versus wavelength before and after a 30 minute bake at 300° C. for coating 8059. With reference to FIG. 3, coatings 8059a and 8059b comprised a 40 nm silver layer deposited onto a 200 nm layer of aluminum. As shown in FIG. 3, the coating 8059a exhibited a reflectivity at 550 nm of around 95% prior to bake; however, the 30 minute bake at 300° C. accelerated interdiffusion between the aluminum and silver layers and generally reduced the reflectivity of the coating 8059b to about 60% in the visible region of the electromagnetic spectrum.

In other embodiments of the present subject matter, barrier layers formed by oxidizing and/or nitriding the aluminum layer may be equally effective in preventing interdiffusion between aluminum and silver layers during the bake. With continued reference to FIG. 2, one coating 8060 illustrates an as-deposited reflectivity for samples in which the aluminum was nitrided after the aluminum was deposited, and another coating 8062 illustrates an as-deposited reflectivity for samples in which the aluminum was oxidized after the aluminum was deposited. In each of the coatings 8060, 8062, 8063, the silver layer had, to some extent, agglomerated, but the silver and aluminum did not interdiffuse. It should be noted that these SiN, oxide and nitride barrier layers are exemplary only and should not limit the scope of the claims appended herewith as other barrier layers were found to prevent interdiffusion between the aluminum and silver layers. For example, a barrier layer comprising TiO₂ was also found to prevent interdiffusion between aluminum and silver layers in coatings according to embodiments of the present subject matter.

Embodiments of the present subject matter may employ a barrier layer having a thickness of between approximately 20-30 nm or less to remain relatively optically inactive as barrier layer thicker than about a quarter of the wavelength of light may introduce undesirable artifacts into the reflectivity spectrum. Exemplary barrier layers should constitute a distinct material between the silver layer and the aluminum layer, preferably a nitride, oxide, oxynitride, etc. Exemplary barrier layers may be, but are not limited to, aluminum nitride, aluminum oxide, silicon nitride, aluminum oxynitride, silicon oxynitride, aluminum silicon nitride, aluminum silicon oxynitride, and titanium dioxide, to name a few. Further, exemplary barrier layers may be formed by exposing the aluminum surface to an oxidizing or nitriding ambient, such as a molecular gas, or to activated species such as those in a plasma or meta-stable gas such as ozone.

Exemplary silver layers according to embodiments of the present subject matter may be between about 5 nm and about 120 nm in total thickness. Below about 5 nm thickness, the silver layer may be difficult to form as a continuous layer and generally provides a low optical activity. Above about 120 nm, the silver layer may be optically opaque, and the aluminum layer does not participate in the reflection. Preferable embodiments may employ silver layer thicknesses below 80 nm as the silver is no longer completely opaque at this thickness; further, the aluminum layer may participate in the reflection of the electromagnetic spectrum for silver layers having a thickness below 80 nm. For suitably designed optical coatings, this combination may enhance the reflectivity of a respective device or reflector, particularly at wavelengths below 450 nm. Exemplary aluminum layers may have a thickness between about 5 nm and about 500 nm. For thicknesses greater than 500 nm, there is relatively little added reflectivity provided by the aluminum layer. For thicknesses less than 5 nm, the optical activity for an aluminum layer is relatively low. While not shown in FIGS. 1A-1D, various optically inactive adhesion layers or other layers may be useful for some types of substrates.

Agglomeration may be prevented in certain embodiments of the present subject matter by having the silver layer in contact with a solid medium opposite the barrier layer. FIG. 1C is an example of such an embodiment where the silver layer 120 is deposited and in contact with the substrate 102. A barrier layer 130 may be deposited substantially overlying the silver layer 120, and an aluminum layer 110 may be deposited substantially overlying the barrier layer 130. Of course, subsequent layers such as, but not limited to, oxides and/or nitrides 122 in contact with the silver layer 120 opposite the barrier layer 130 may also prevent agglomeration of the silver layer 120 as illustrated in FIG. 1D.

The specific design of the capping layer may generally depend upon optical and durability requirements of respective devices. The capping layer may be, in certain embodiments, greater than 1 nm in thickness. For thinner capping layers, the effectiveness of the layer in improving durability is not useful. The capping layer may also be provided as the substrate in embodiments where a mirror is a second surface mirror. Capping layer materials may be selected from a wide range of materials such as, but not limited to, metals, silicon dioxide, titanium dioxide, silicon nitride, and other oxides, nitrides, or organic materials. Exemplary capping layers may improve the durability of the reflector coating and improve the resistance of the coating to humidity, high temperatures, and corrosion. For capping layers having a thickness greater than about 100 nm, the capping layer may also improve the mechanical durability of the reflective coating.

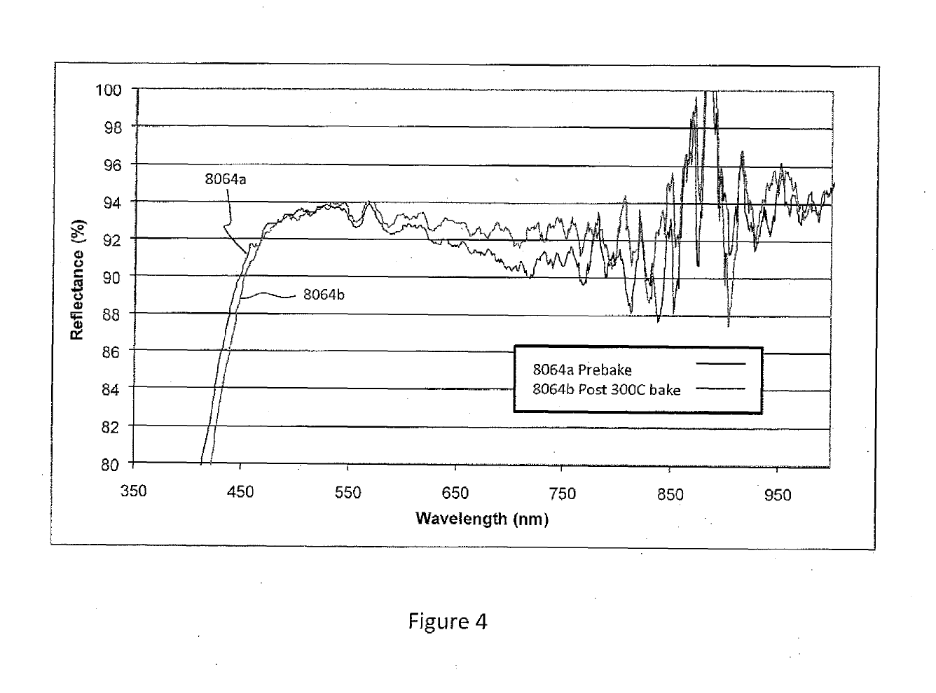

FIG. 4 is a graphical representation of reflectivity versus wavelength for another embodiment of the present subject matter. With reference to FIG. 4, coatings 8064a and 8064b comprised a 40 nm silver layer deposited onto a 200 nm layer of aluminum. The layer of aluminum was nitrided after deposit thereof, and a 1 nm layer of titanium deposited on the layer of silver (the Ti layer may oxidize during processing). A 60 nm SiO₂ buffer layer was deposited on the titanium layer, and a 36 nm TiO₂ capping layer deposited on the SiO₂ layer. As shown in FIG. 4, the coating 8064a exhibited a reflectivity of around 96% at a wavelength of 550 nm prior to bake. After the bake, the coating 8064b exhibited a reflectivity of around 95% at 550 nm. In this particular embodiment, it is apparent that the buffer layer and capping layer provided an improved bake durability and the dielectric stack provided an increased blue reflectivity.

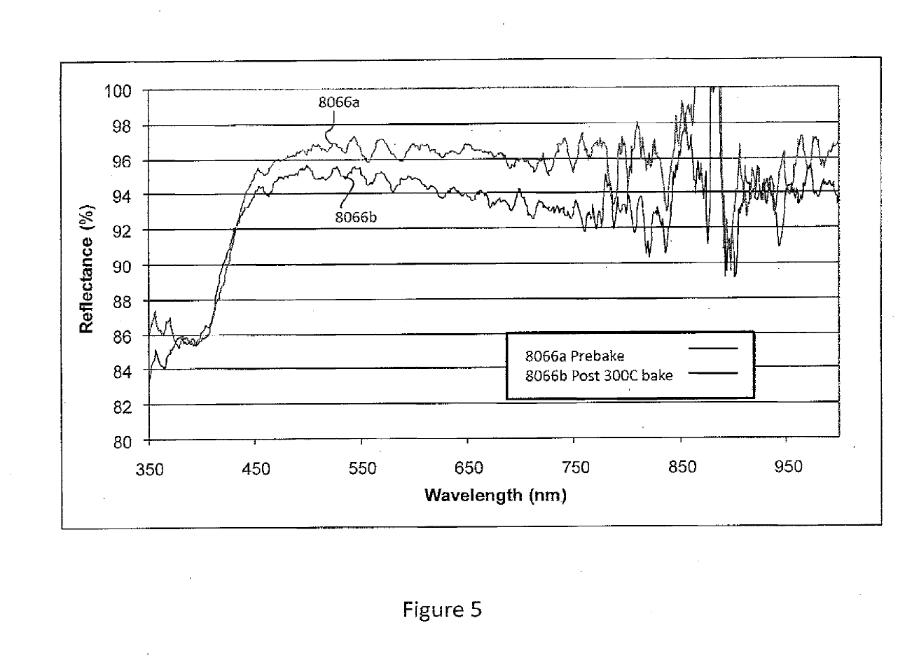

FIG. 5 is a graphical representation of reflectivity versus wavelength for a further embodiment of the present subject matter. With reference to FIG. 5, coatings 8066a and 8066b comprised a 60 nm silver layer deposited onto a 200 nm layer of aluminum. The layer of aluminum was nitrided after deposit thereof, and a 1 nm layer of titanium deposited on the layer of silver (the Ti layer may oxidize during processing). A 55 nm SiO₂ buffer layer was deposited on the titanium layer, and a 33 nm TiO₂ capping layer was deposited on the SiO₂ layer. As shown in FIG. 5, the coating 8066a exhibited a reflectivity of around 96% at a wavelength of 550 nm prior to bake. After the bake, the coating 8066b exhibited a reflectivity of around 95% at 550 nm. In this embodiment, the buffer layer and capping layer provided an improved bake durability, and the dielectric stack provided an increased blue reflectivity.

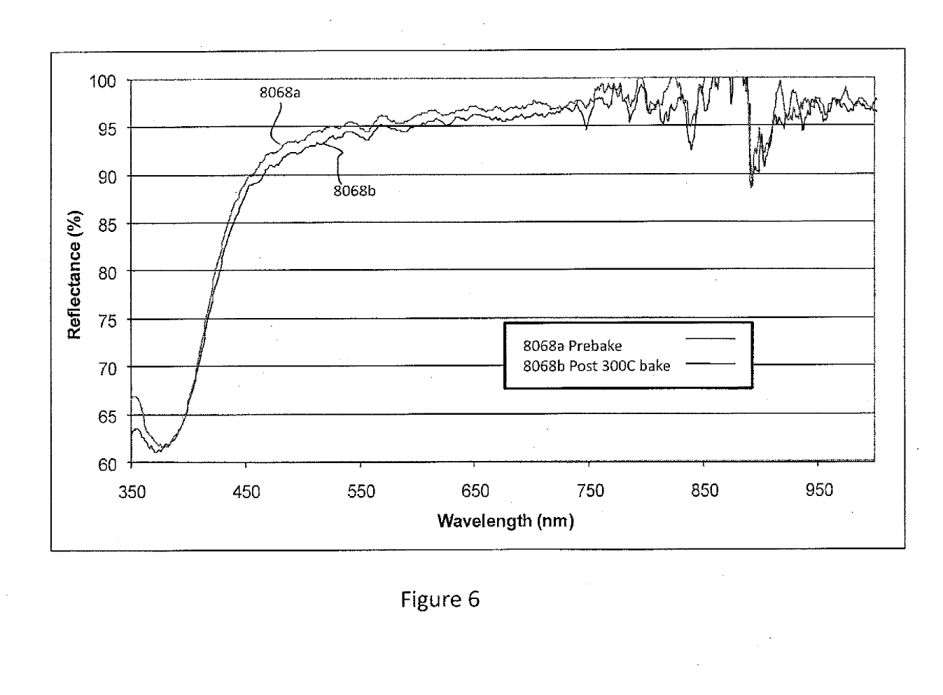

FIG. 6 is a graphical representation of reflectivity versus wavelength for one embodiment of the present subject matter. With reference to FIG. 6, coatings 8068a and 8068b comprised a 60 nm silver layer deposited onto a 200 nm layer of aluminum. The layer of aluminum was nitrided after deposit thereof, and a 1 nm layer of titanium deposited on the layer of silver (the Ti layer may oxidize during processing). A 10 nm SiN layer was deposited on the titanium layer. As shown in FIG. 6, the coating 8068a exhibited a reflectivity of around 95% at a wavelength of 550 nm prior to bake. After the bake, the coating 8068b also exhibited a reflectivity of around 95% at 550 nm. In this embodiment, the SiN layer provided an improved bake durability.

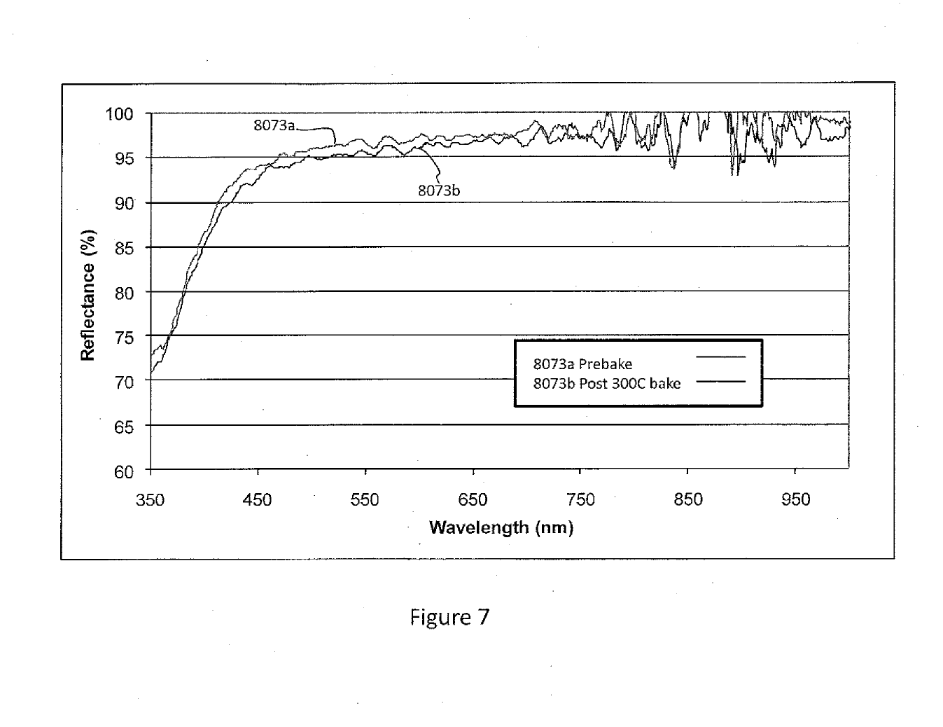

FIG. 7 is a graphical representation of reflectivity versus wavelength for a further embodiment of the present subject matter. With reference to FIG. 7, coatings 8073a and 8073b comprised a 60 nm silver layer deposited onto a 200 nm layer of aluminum. The layer of aluminum was nitrided after deposit thereof, and a 1 nm layer of titanium deposited on the layer of silver (the Ti layer may oxidize during processing). A 5 nm SiN layer was deposited on the titanium layer. As shown in FIG. 7, the coating 8073a exhibited a reflectivity of around 96% at a wavelength of 550 nm prior to bake. After the bake, the coating 8073b also exhibited a reflectivity of around 95% at 550 nm. In this embodiment, the SiN layer provided an improved bake durability, and the stack provided an improved blue reflectivity.

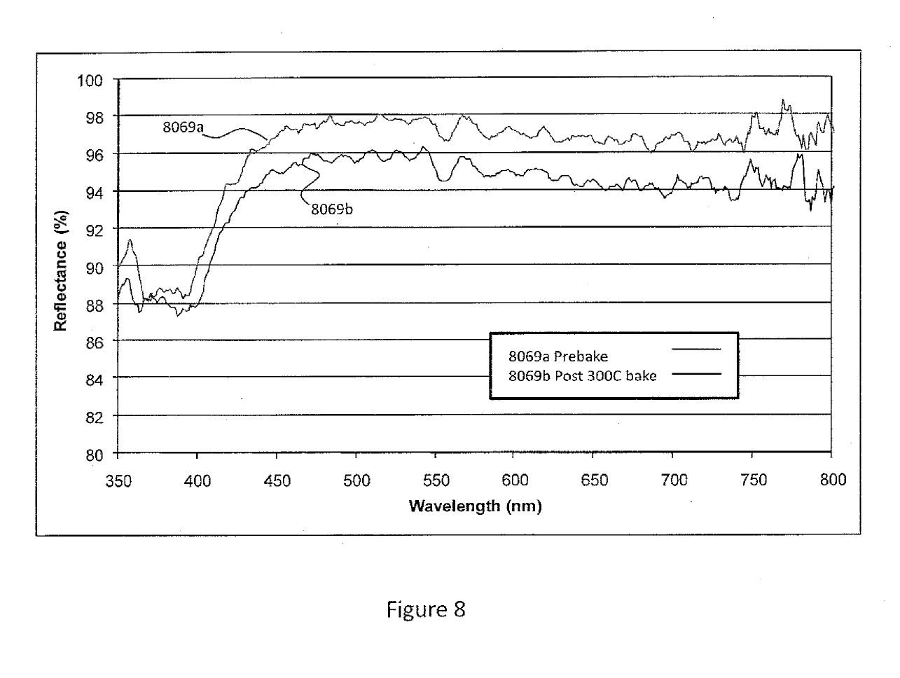

FIG. 8 is a graphical representation of reflectivity versus wavelength for an additional embodiment of the present subject matter. With reference to FIG. 8, coatings 8069a and 8069b comprised a 5 nm barrier layer of TiO₂ deposited onto a 200 nm layer of aluminum, and a 120 nm silver layer deposited on the barrier layer. A 1 nm layer of titanium was deposited on the layer of silver (the Ti layer may oxidize during processing). A 50 nm SiO₂ buffer layer was deposited on the titanium layer, and a 30 nm TiO₂ capping layer deposited on the SiO₂ layer. As shown in FIG. 8, the coating 8069a exhibited a reflectivity of around 97% at a wavelength of 550 nm prior to bake. After the bake, the coating 8069b exhibited a reflectivity of around 95% at 550 nm. In this embodiment, the buffer layer and capping layer provided an improved bake durability, and the barrier provided an improved blue reflectivity.

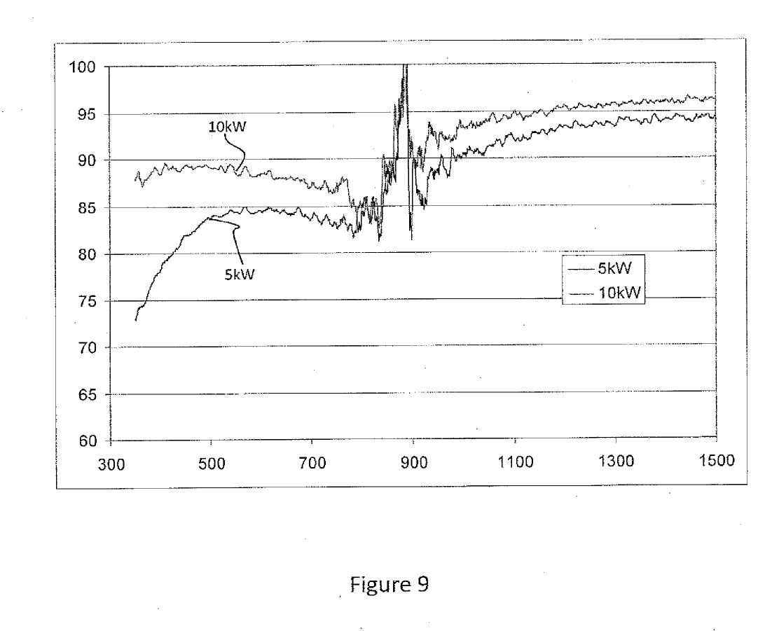

Reflectivity of embodiments of the present subject matter may also be affected by deposition power. FIG. 9 is a graphical representation of reflectivity versus wavelength for bare aluminum deposited at different powers. With reference to FIG. 9, the reflectivity of a bare 200 nm thick layer of sputtered aluminum is illustrated deposited at a low power (5 kW) and at high power (10 kW). The aluminum deposited at 10 kW power has a higher purity and is more reflective. Of course, an aluminum layer having an increased reflectivity is desired in embodiments of the present subject matter, particularly for increased reflectivity at wavelengths below 500 nm.

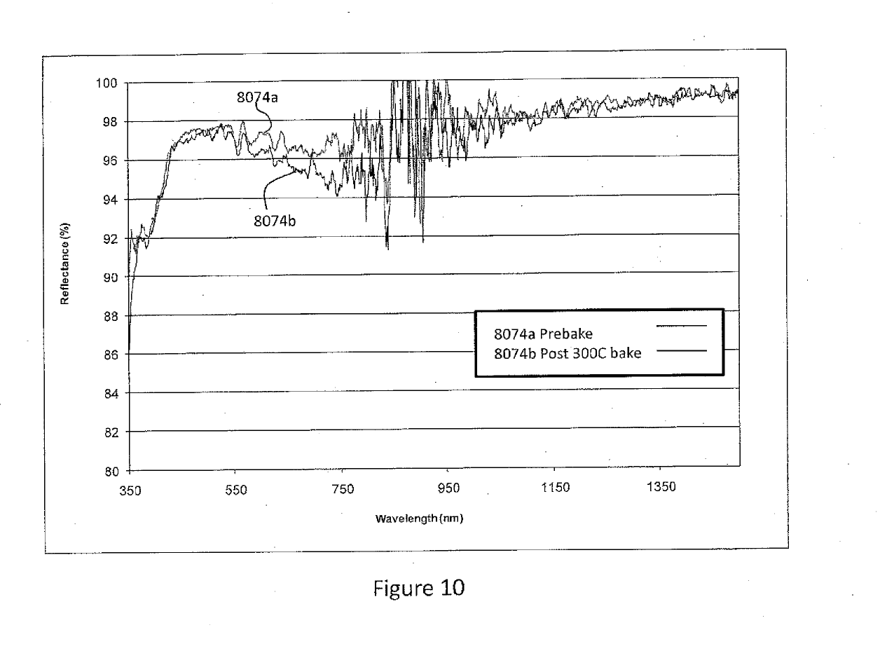

FIG. 10 is a graphical representation of reflectivity versus wavelength for one embodiment of the present subject matter. With reference to FIG. 10, coatings 8074a and 8074b comprised a 5 nm barrier layer of TiO₂ deposited onto a 200 nm layer of aluminum. A 120 nm silver layer was deposited on the barrier layer at approximately 10 kW. A 1 nm layer of titanium was deposited on the layer of silver (the Ti layer may oxidize during processing), a 50 nm SiO₂ buffer layer was deposited on the titanium layer, and a 30 nm TiO₂ capping layer was deposited on the SiO₂ layer. As shown in FIG. 10, the coating 8074a exhibited a reflectivity of around 98% at a wavelength of 550 nm prior to bake. After the bake, the coating 8074b exhibited a reflectivity of around 97% at 550 nm. In this embodiment, the buffer layer and capping layer provided an improved bake durability, and the barrier provided an improved blue reflectivity. Further, when compared to the results in FIG. 8, the reflectivity in the range 350-400 nm increased in coatings 8074a/b from about 88% to about 92% due to the purity of the aluminum deposited at the higher power.

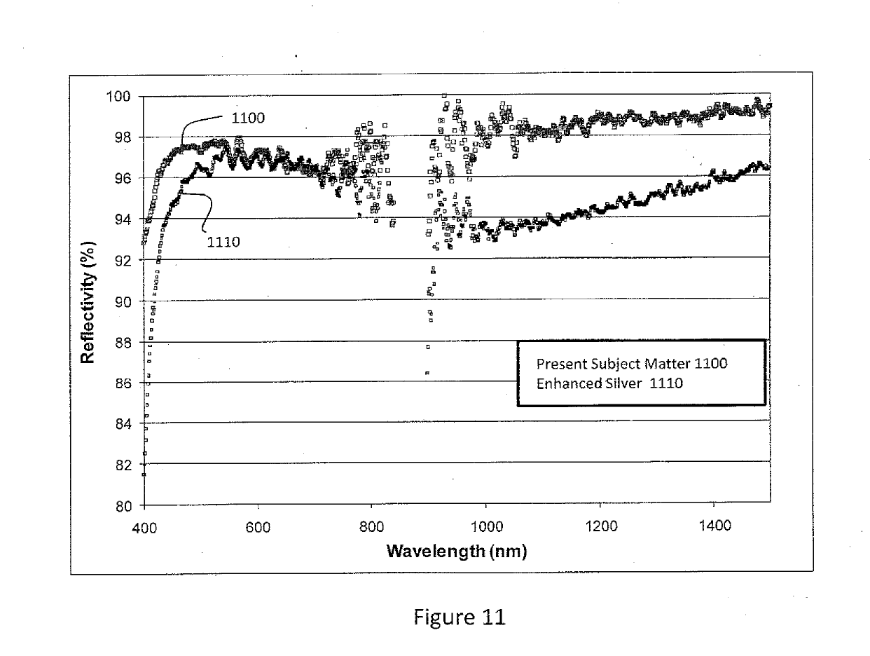

FIG. 11 is a graphical representation of a comparison of one embodiment of the present subject matter and a conventional enhanced silver coating. With reference to FIG. 11, it is apparent that a coating 1100 having the structure described in FIG. 10 may achieve a significantly higher reflectivity than a conventional “enhanced silver” coating 1110 with a 120 nm thickness silver layer, a 1 nm titanium layer deposited thereon, a 60 nm SiO₂ layer deposited on the titanium layer, and a 36 nm TiO₂ layer deposited on the SiO₂ layer. Further, embodiments of the present subject matter achieve higher reflectivity using about half the amount of silver of that required in a conventional “enhanced silver” coating.

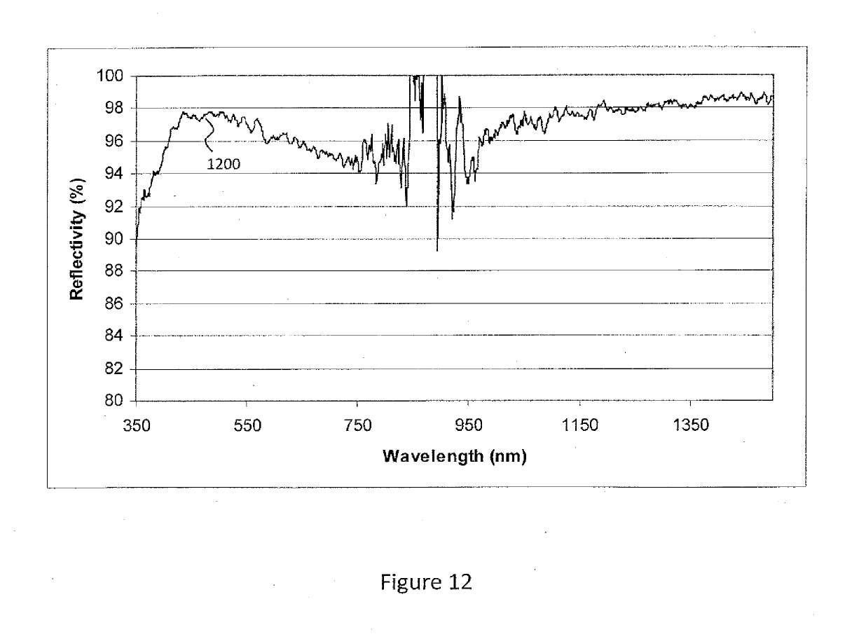

FIG. 12 is a graphical representation of reflectivity versus wavelength for yet another embodiment of the present subject matter. With reference to FIG. 12, an exemplary coating 1200 comprised a 5 nm barrier layer of TiO₂ deposited onto a 50 nm layer of aluminum. A 60 nm silver layer was deposited on the barrier layer at approximately 10 kW. A 1 nm layer of titanium was deposited on the layer of silver (the Ti layer may oxidize during processing). A 50 nm SiO₂ buffer layer was deposited on the titanium layer, and a 30 nm TiO₂ capping layer was deposited on the SiO₂ layer. The total metal thickness of the coating was 110 nm and the overall coating thickness was 190 nm. As shown in FIG. 12, the coating 1200 exhibited a reflectivity higher than that of either silver or aluminum throughout the range of 350-550 nm.

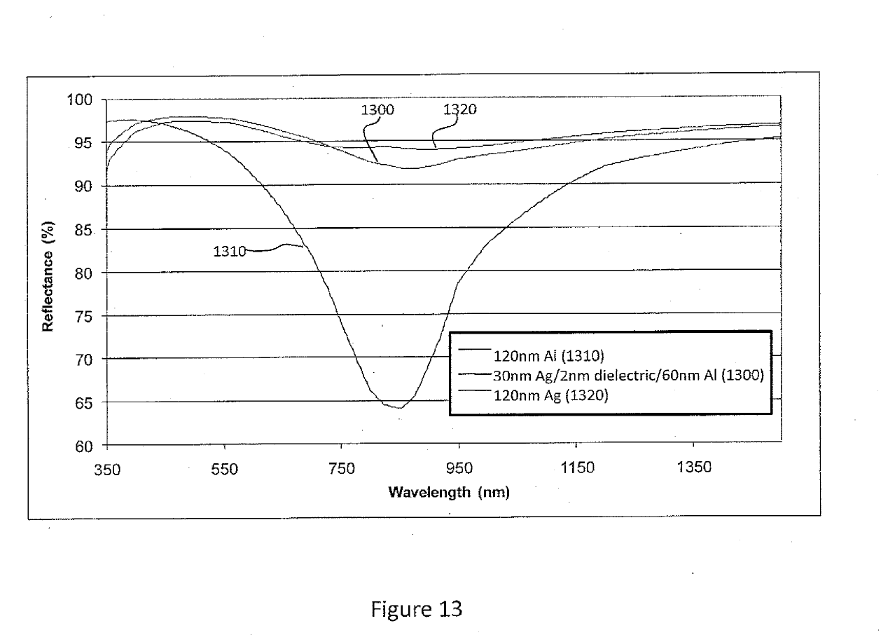

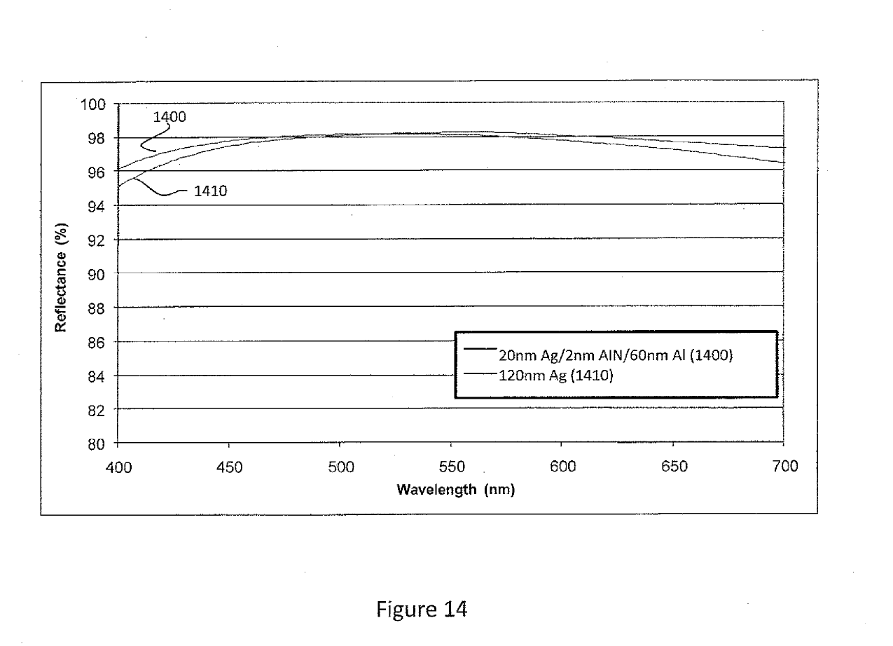

FIG. 13 is a simulated result illustrating an optical performance of enhanced aluminum, enhanced silver, and one embodiment of the present subject matter. FIG. 14 is a simulated result illustrating an optical performance for enhanced silver optimized for lighting compared to an embodiment of the present subject matter. With reference to FIGS. 13 and 14, one embodiment of the present subject matter comprised a 2 nm dielectric barrier layer deposited on a 60 nm aluminum layer. A 30 nm (FIG. 13) or 20 nm (FIG. 14) silver layer was deposited on the barrier layer. When compared to an enhanced silver coating 1310 and an aluminum coating 1320, the exemplified embodiment 1300 provided a higher blue reflectance, improved visible reflectance, and utilized significantly less silver (in the case of the silver coating 1310).

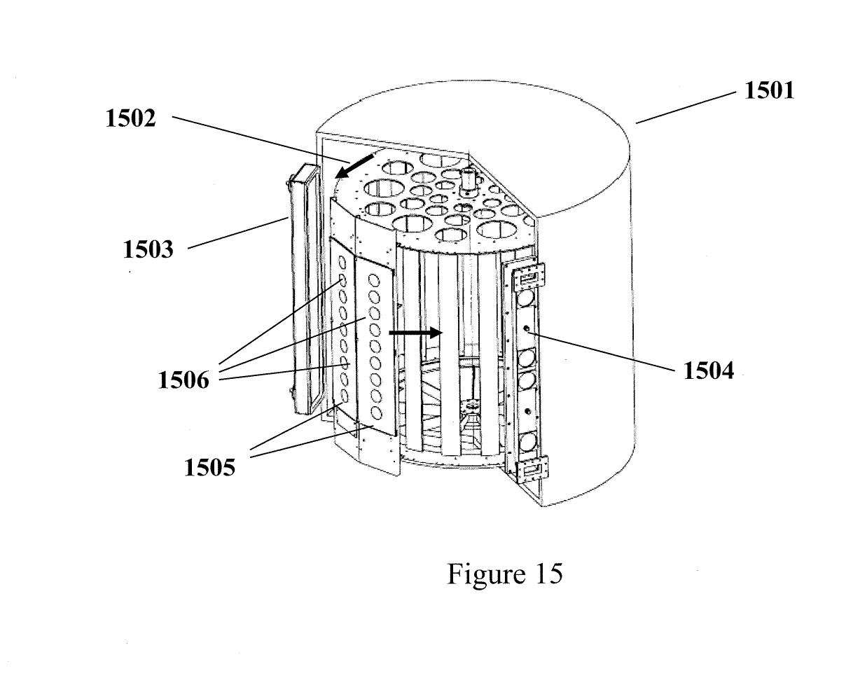

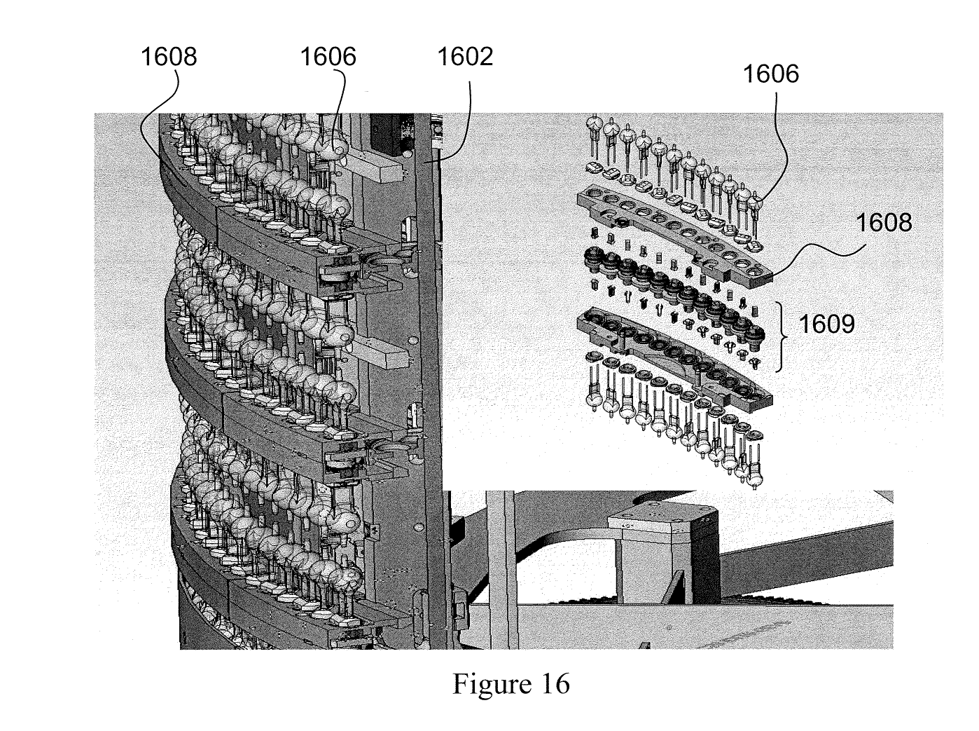

Multilayer coatings according to embodiments of the present subject matter may be manufactured or produced in any number of methods. For example, exemplary coatings may be sputtered utilizing magnetron sputtering systems. FIG. 15 is a perspective view of a conventional magnetron sputtering system. With reference to FIG. 15, a conventional magnetron sputtering system may utilize a cylindrical, rotatable drum 1502 mounted in a vacuum chamber 1501 having sputtering targets 1503 located in a wall of the vacuum chamber 1501. Plasma or microwave generators 1504 known in the art may also be located in a wall of the vacuum chamber 1501. Substrates 1506 may be removably affixed to panels or substrate holders 1505 on the drum 1502. FIG. 16 is a perspective view of another magnetron sputtering system. With reference to FIG. 16, a plurality of substrates 1606, such as lamp burners, reflectors, mirrors, etc., may be attached to the rotatable drum 1602 via a conventional substrate holder 1608. Conventional substrate holders 1608 generally include a plurality of gears and bearings 1609 allowing one or more substrates 1606 to rotate about its respective axis. Material from the sputtering target 1603 may thus be distributed around the substrates 1606 as they pass a target 1603. Obtaining sufficient uniformity in coating may require plural rotations past the target 1603 or may require multiple targets.

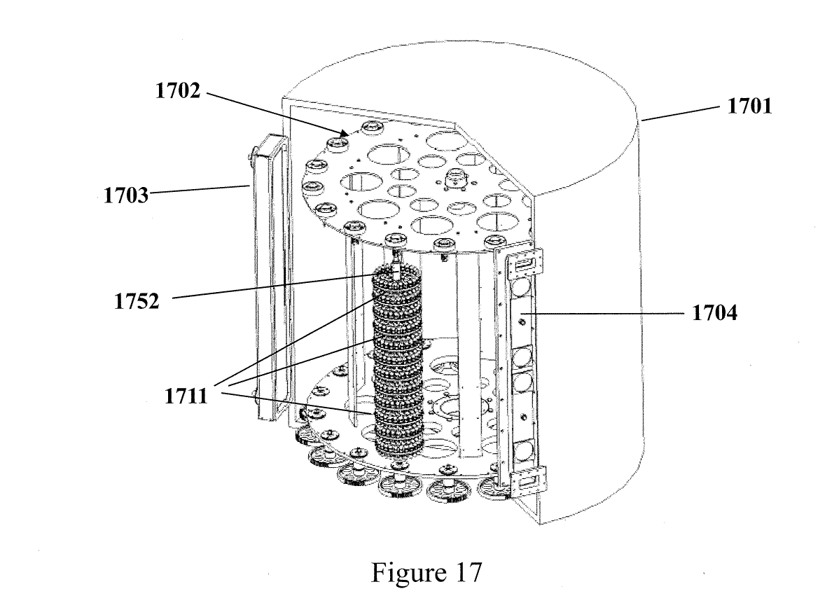

Embodiments of the present subject matter may also be manufactured in sputtering systems having tooling allowing more than one degree of rotational freedom. FIG. 17 is a perspective view of a such a sputtering system. With reference to FIG. 17, an exemplary sputtering system may utilize a substantially cylindrical, rotatable drum or carrier 1702 mounted in a vacuum chamber 1701 having sputtering targets 1703 located in a wall of the vacuum chamber 1701. Plasma or microwave generators 1704 known in the art may also be located in a wall of the vacuum chamber 1701. The carrier 1702 may have a generally circular cross-section and is adaptable to rotate about a central axis. A driving mechanism (not shown) may be provided for rotating the carrier 1702 about its central axis. A plurality of pallets 1750 may be mounted on the carrier 1702 in the vacuum chamber 170. Each pallet 1750 may comprise a rotatable central shaft 1752 and one or more disks 1711 axially aligned along the central shaft 1752. The disks 1711 may provide a plurality of spindle carrying wells positioned about the periphery of the disk 1711. Spindles may be carried in the wells, and each spindle may carry one or more substrates, such as a lamp, reflector, mirror, etc., adaptable to rotate about it respective axis. Additional particulars and embodiments of this exemplary system are further described in co-pending and related U.S. patent application Ser. No. 12/155,544, filed Jun. 5, 2008, entitled, “Method and Apparatus for Low Cost High Rate Deposition Tooling,” and co-pending U.S. application Ser. No. 12/289,398, filed Oct. 27, 2008, entitled, “Thin Film Coating System and Method,” the entirety of each being incorporated herein by reference. Of course, embodiments of the present subject matter may also be manufactured using an in line coating mechanism or sputtering system and/or any conventional chemical vapor deposition system. Exemplary methods of producing a multilayer reflective coating may include depositing a layer of aluminum onto a substrate, oxidizing or nitriding the deposited layer of aluminum, depositing a layer of silver over the oxidized or nitrided layer of aluminum, and depositing a capping layer over the deposited layer of silver. Another method of producing a multilayer reflective coating may include depositing a layer of aluminum onto a substrate, depositing a barrier layer over the deposited layer of aluminum, and depositing a layer of silver over the barrier layer. This barrier layer may be formed from material that substantially inhibits interdiffusion between the aluminum and silver layers.

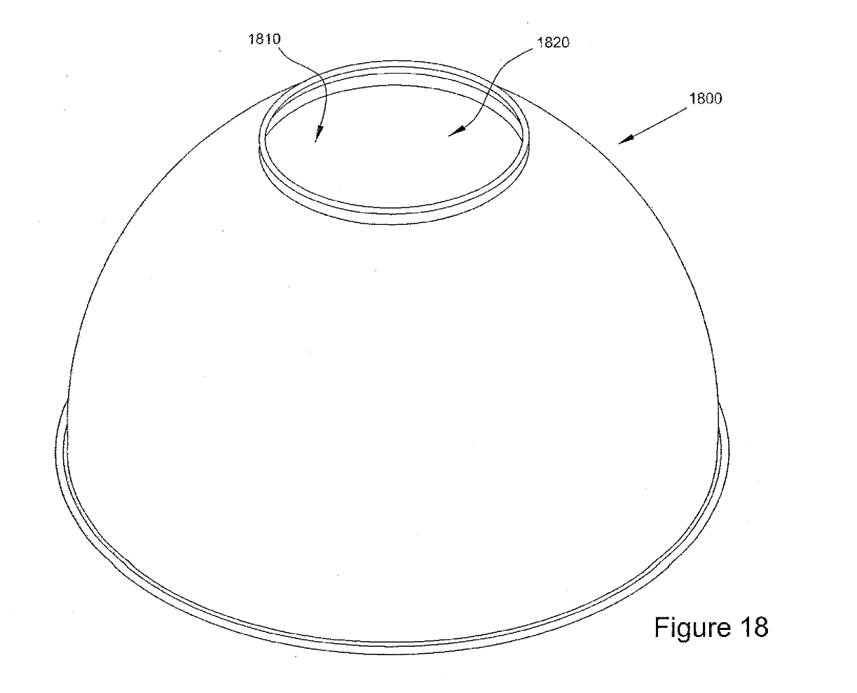

Exemplary multilayer coatings according to embodiments of the present subject matter may be employed in a myriad of applications. FIG. 18 is a perspective view of a reflector according to an embodiment of the present subject matter. With reference to FIG. 18, a reflector 1800 may be constructed of highly reflective light-gauge metallic or other suitable material. It is contemplated that the reflector 1800 may also be any coated or uncoated glass, plastic or metallic material, or ceramic material typical of those utilized in the art for distributing light. Surfaces of the reflector 1800 including the surface 1810 facing a light source (not shown) may comprise one or plural coatings of vaporized and/or sputtered materials as described in any of the embodiments above to increase reflectance values and may, in certain embodiments, permit some distribution of light to illuminate adjacent structures such as a ceiling. Other exemplary materials may be, but are not limited to, polymeric prismatic materials. The surface 1810 may be substantially smooth or may also be provided with micro-reflectors designed to capture light beams from the light source and redirect the beams in a pre-calculated and/or uniform fashion. The reflector 1800 may also deflect a portion of the infrared heat generated by the light source. The reflector 1800 may be provided with a hemispheroidal, conical or other suitable geometry, curved (e.g., concave or convex) or planar, for directing light at angles of varying degrees according to a desired lighting pattern.

One exemplary reflector 1800 may comprise a substrate having a surface 1810 where the surface includes a multilayer coating 1820 formed on at least a portion thereof. The coating may include a layer of aluminum overlying at least a portion of the substrate surface, a barrier layer overlying at least a portion of the aluminum layer, and a layer of silver overlying at least a portion of the barrier layer. The aluminum layer may have a substantially uniform thickness between 5 nm and 500 nm. The barrier layer may also have a substantially uniform thickness of less than approximately 30 nm. The barrier layer may be formed from one or more materials that substantially inhibits interdiffusion of the aluminum and silver such as, but not limited to, aluminum nitride, silicon nitride, aluminum oxynitride, silicon oxynitride, aluminum silicon nitride, aluminum silicon oxynitride, and titanium dioxide. The silver layer may have a substantially uniform thickness between 5 nm and 120 nm. One exemplary coating on the reflector may also include a capping layer overlying at least a portion of the silver layer, where the capping layer has a substantially uniform thickness greater than 1 nm. The capping layer may be formed from one or more materials such as, but not limited to, metals, oxides, and nitrides. In one embodiment, the thickness of the multilayer coating may be less than 300 nm, and the reflector may also provide a reflectivity at 450 nm of at least 95 percent depending upon the coating applied to the surface 1810. Of course, the coating, materials and thicknesses thereof are exemplary only and should not limit the scope of the claims appended herewith. While FIG. 18 has been described as a reflector for a lamp, embodiments of the present subject matter should not be so limited as the reflector may also be a curved or planar reflective mirror, etc.

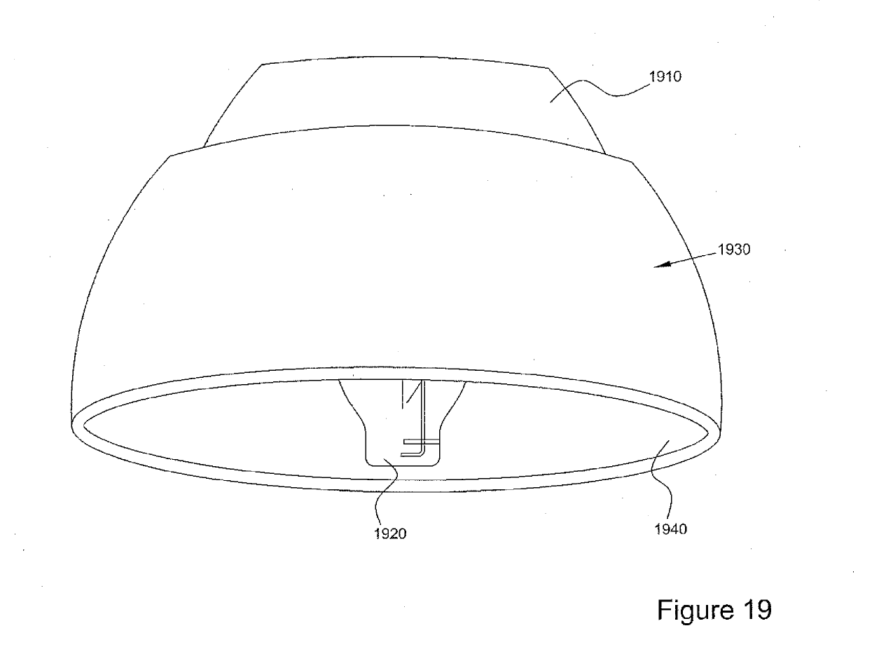

FIG. 19 is a perspective view of a lamp according to an embodiment of the present subject matter. With reference to FIG. 19, a lamp or luminaire 1900 may comprise a housing 1910 having a socket positioned therein to operatively and removeably receive a light source 1920. The light source 1920 may be any suitable type of lamp (e.g., halogen, high intensity discharge, compact fluorescent, incandescent, and the like). The lamp 1900 may also include a reflector 1930 supported from the housing 1910. The reflector 1930 may be positioned to encompass the light source 1920 operatively received in the socket and may be positioned apart from or substantially flush to the housing 1910. The reflector 1930 may include a reflective surface 1940 covering a portion of a surface of the reflector 1930 facing the light source 1920. The reflective surface 1940 may comprise a multilayer coating having layers of aluminum and silver separated by a barrier layer formed from a material that substantially inhibits interdiffusion of the aluminum and silver. The coating may also include, in another embodiment, a capping layer over the silver layer. Any type of multilayer coating according to embodiments of the present subject matter may be deposited on the surface 1940 of the reflector 1930 to achieve a desirable reflectivity and/or light distribution.

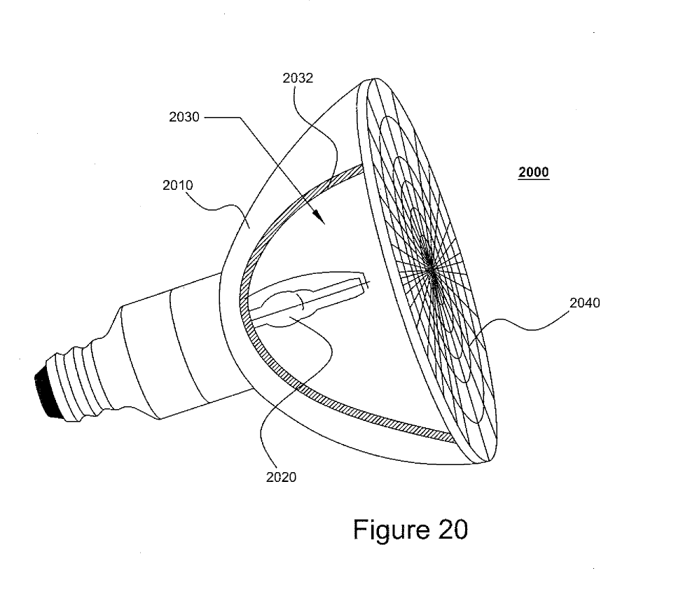

FIG. 20 is a perspective cut-away view of another lamp according to an embodiment of the present subject matter. With reference to FIG. 20, an exemplary lamp 2000 may comprise a housing 2010 and a light source 2020 within the housing 2010. A reflective surface 2032 may cover a portion or substantially all of an interior surface 2030 of the housing 2010. In one embodiment, the housing 2010 may also include a lens 2040 to complete an enclosure of the light source 2020. The reflective surface 2032 may include a multilayer coating having layers of aluminum and silver separated by a barrier layer formed from a material that substantially inhibits interdiffusion of the aluminum and silver. Any type of multilayer coating according to embodiments of the present subject matter may be deposited on the surface 2030 of the housing 2010 to achieve a desirable reflectivity and/or light distribution and may also include a capping layer over the silver layer. The light source 2020 may be any suitable type of lamp (e.g., halogen, high intensity discharge, incandescent, and the like). Exemplary lamps 2000 (which may also be referred to in the industry as reflectors) may be, but are not limited to, parabolic aluminized reflectors (“PAR”), parabolic reflectors, bulged reflectors (“BR”), elliptical reflectors, blown parabolic reflectors, multifaceted reflectors (“MR”), sealed beam reflectors, aluminum reflector (“ALR”) lamps, indoor lamps, outdoor lamps, and the like. Additionally, an exemplary lamp 2000 may have any number of dimensions. For example, a PAR 38 lamp represents a PAR lamp having an outside diameter of 38/8 inches, a BR30 lamp represents a BR lamp having a reflector of 30/8 inches in diameter, an MR16 lamp represents an MR lamp where 16 is the number of eighths of an inch the front thereof is in diameter (in this case 2 inches), and so forth.

Embodiments of the present subject matter may also find utility in a variety of solar energy applications and systems. Exemplary systems may be a photovoltaic system having modules with concentrating optical components. It is well known that the efficiency of a heat engine or turbine increases with the temperature of the heat source. To achieve this increase in efficiency in solar energy systems, solar radiation may be concentrated by mirrors or lenses to obtain higher temperatures. This is commonly referred to as concentrated solar power. There are a multitude of concentrated solar power applications in which embodiments of the present subject matter may find utility. For example, a concentrator system (“C-system”) is a photovoltaic (“PV”) system having a plurality of modules with concentrating optical components.

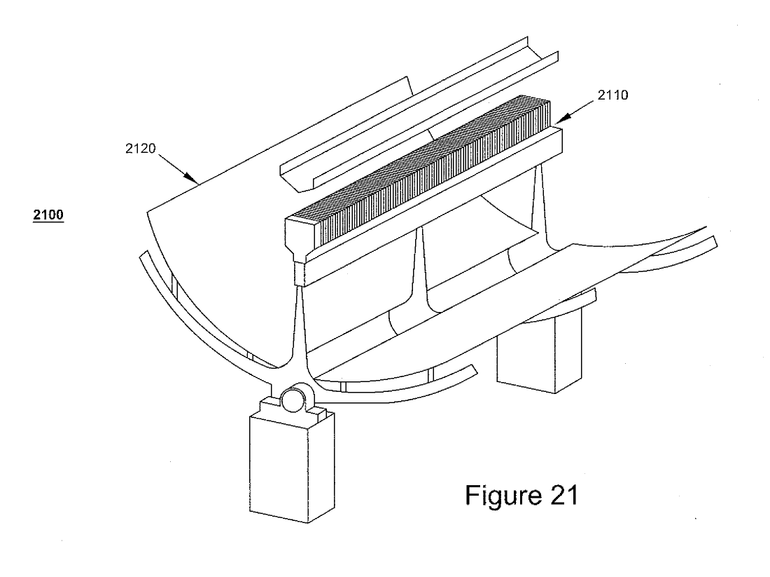

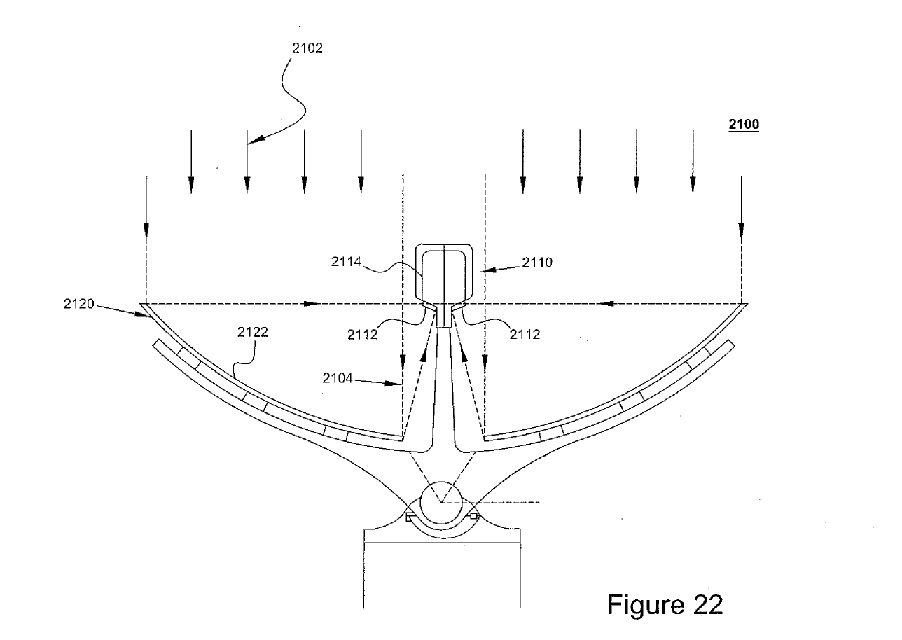

A C-System may comprise one or more C-modules and a balance of system (“BOS”) mechanism. FIG. 21 is a perspective view of a C-module, and FIG. 22 is a cross-sectional diagram of a C-module. With reference to FIGS. 21 and 22, an exemplary C-module 2100 may include a protected assembly of receivers 2110 and optics, and related components such as interconnects and mounting, that accepts unconcentrated solar energy 2102. The receiver 2110 may be an assembly of one or more PV cells 2112 accepting concentrated sunlight 2104 and incorporating components 2114 to dissipate excess heat (“heat sink”) produced by the concentrated solar energy and/or circuitry for electric energy removal. The C-Module 2100 may also include a primary collector 2120 receiving solar energy and focusing the solar energy or sunlight 2104 onto the receiver 2110 and/or a secondary concentrator. In an exemplary C-Module 2110, the collector 2120 may be a lens or reflective mirror. This reflective mirror may be parabolic, curved, planar, etc. depending upon the requirements of the respective C-System. In one embodiment, the collector may have a reflective surface 2122 covering a substantial portion of a surface of the collector 2120. The reflective surface 2122 may comprise a multilayer coating having layers of aluminum and silver separated by a barrier layer formed from a material that substantially inhibits interdiffusion of the aluminum and silver. The coating may also include, in another embodiment, a capping layer over the silver layer. Of course, any type of multilayer coating according to embodiments of the present subject matter described in previous paragraphs may be deposited on the surface 2122 of the collector 2120.

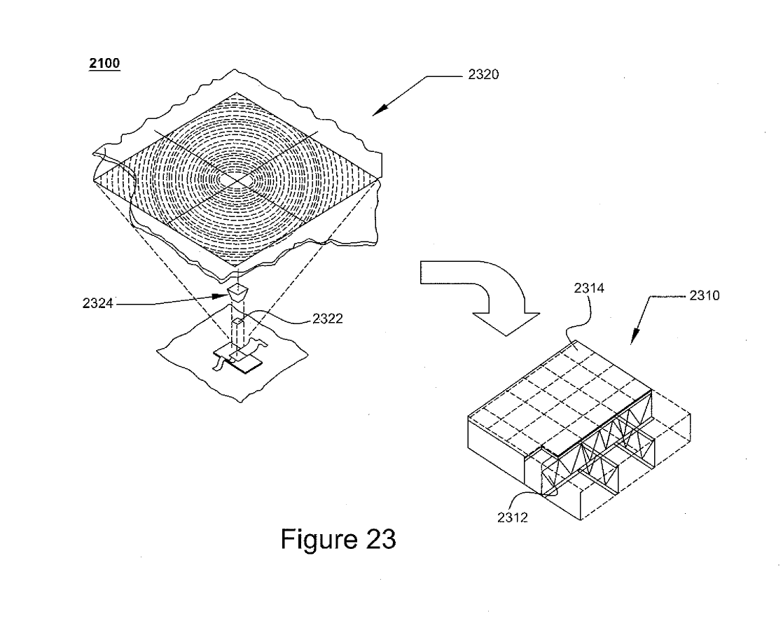

The C-module 2100 may also include a secondary concentrator. FIG. 23 is an exploded diagram of an exemplary secondary concentrator. With reference to FIG. 23, a secondary concentrator 2300 may be an optical component or module 2310 of components receiving concentrated sunlight or solar energy 2104 from the primary collector 2120 and focusing the concentrated energy 2104 onto the receiver 2110 to increase angular acceptance or uniformity of the light. The angular acceptance or field or view (q) is the maximum angle between the solar ray and the normal to the collector plane for which the ray will fall on the active area of the receiver 2110. The optical components may focus the sunlight 2104 onto a PV cell, a circular or squared parquet of PV cells, a linear array 2112 of PV cells, etc. Point focus embodiments are those focusing the sunlight 2104 on a PV cell or parquet of PV cells. Linear focus embodiments are those focusing the sunlight 2104 on a linear array 2112 of PV cells. While FIGS. 21-22 have been illustrated as a linear focus embodiment, such a depiction should not limit the scope of the claims appended herewith as exemplary multilayer coatings may be employed in any solar focusing embodiment. For example, FIG. 23 illustrates one C-module 2300 example employing a point focus Fresnel lens 2320 as collector and a secondary concentrator 2310. In this example the C-module 2300 may comprise a housing structure 2312 having 36 cell packages 2314 and 36 point focus Fresnel lenses 2320 assembled in a 6×6 mosaic. The cell package 2314 may include a PV cell 2322 mounted on a substrate with accessories for thermal cooling and support of the secondary optical element. Another layer 2324 of optically enhancing or optically neutral material, e.g., glass, may also overlay the cell 2322. A plurality or array of C-modules 2100 may be connected together to provide a single electrical output. This array may be a mechanically integrated assembly of modules or panels having a support structure, but exclusive of the foundation, tracking apparatus, thermal control and other such components, to form a direct current power producing unit. A collection of C-modules 2100 assembled in a single mechanical frame may be referred to as a panel and may serve as an installable unit in an array and/or subarray.

A BOS may include the tracking mechanism, module support structures, external wiring and connection boxes, power conditioning equipment, energy storage batteries, data acquisition equipment, etc. Generally, the tracking mechanism (single-axis, two-axis) may be employed to keep the cells in focus. Single-axis tracking mechanisms follow the sun daily from east to west on the sun's path. Two-axis tracking mechanisms include corrections for seasonal north-south sun movement. Most concentrator systems employ a tracking mechanism and embodiments of the present subject matter may be utilized in concentrators having a large angular acceptance accepting diffused light.

In another embodiment, an exemplary C-System may be a parabolic trough power plant utilizing one or more curved troughs having reflective mirror(s) with an exemplary multilayer coating that reflects direct solar radiation onto a receiver containing a fluid laden pipe running the length of the trough above the reflective mirror and along a focal point or plane. Common fluids are synthetic oil, molten salt, water, pressurized steam, graphite, etc., and may be transported to a heat engine or turbine where the heat can be converted to electricity.

In yet a further embodiment, an exemplary C-System may be a heliostat power plant employing an array of planar or curved moveable reflective mirrors (“heliostats”) to focus solar radiation upon a central collector tower or receiver. The heliostats may employ exemplary multilayer coatings according to embodiments of the present subject matter. The central receiver may include a plurality of fluid laden piping where the heated fluid (synthetic oil, molten salt, water, pressurized steam, graphite, etc.) may be transported to a heat engine or turbine and converted to electricity.

Multilayer coatings according to embodiments of the present subject matter may also be employed in dish C-Systems that generally employ a large, reflective, parabolic dish or plural smaller reflective surfaces to focus incident sunlight on the dish to a single point above the dish where a receiver captures the heat and transforms it into a useful form. Further, multilayer coatings according to embodiments of the present subject matter may be employed in solar cookers that utilize reflectors or reflective mirrors (planar, parabolic, etc.) to concentrate light on a cooking container.

As shown by the various configurations and embodiments illustrated in FIGS. 1A-23, the various embodiments of optical spectrally selective coatings and methods have been described.

While preferred embodiments of the present subject matter have been described, it is to be understood that the embodiments described are illustrative only and that the scope of the invention is to be defined solely by the appended claims when accorded a full range of equivalence, many variations and modifications naturally occurring to those of skill in the art from a perusal hereof.

What we claim is:

1. A multilayer reflective coating comprising layers of aluminum and silver and a barrier layer disposed between the aluminum and silver layers, said barrier layer being formed from material that substantially inhibits interdiffusion between the aluminum and silver layers.

2. The multilayer coating of claim 1 further comprising a capping layer disposed over said silver layer.

3. The multilayer coating of claim 1 wherein said barrier layer is substantially optically transparent.

4. The multilayer coating of claim 1 wherein the thickness of said aluminum layer is less than 100 nm.

5. The multilayer coating of claim 4 wherein the thickness of said silver layer is between 5 nm and 100 nm.

6. The multilayer coating of claim 1 wherein the thickness of said aluminum layer is between 5 nm and 500 nm.

7. The multilayer coating of claim 1 wherein the thickness of said silver layer is between 5 nm and 100 nm.

8. The multilayer coating of claim 1 wherein the thickness of said barrier layer is less than 30 nm.

9. The multilayer coating of claim 1 wherein the barrier layer is formed from one or more materials selected from the group consisting of nitrides, oxides and oxynitrides.

10. The multilayer coating of claim 9 wherein said barrier layer is formed from one or more materials selected from the group consisting of: aluminum nitride, silicon nitride, aluminum oxynitride, silicon oxynitride, aluminum silicon nitride, aluminum silicon oxynitride, and titanium dioxide.

11. A multilayer reflective coating comprising layers of aluminum and silver and a layer disposed between the aluminum and silver layers, wherein said layer between the aluminum and silver layers does not comprise nickel or chromium.

12. The multilayer coating of claim 11 having a thickness less than 200 nm.

13. The multilayer coating of claim 11 further comprising a capping layer overlying said silver layer wherein the thickness of said coating is less than 300 nm.

14. A multilayer coating of claim 11 wherein the barrier layer is formed from one or more materials selected from the group consisting of: aluminum nitride, silicon nitride, aluminum oxynitride, silicon oxynitride, aluminum silicon nitride, aluminum silicon oxynitride, and titanium dioxide.

15. A reflective surface comprising a multilayer thin film coating having layers of aluminum and silver and a barrier layer therebetween, wherein said barrier layer is formed by oxidizing or nitriding the outermost portion of the aluminum layer.

16. A multilayer reflective coating consisting of layers of aluminum and silver.

17. The multilayer coating of claim 16 wherein the thickness of said aluminum layer is between 5 nm and 500 nm.

18. The multilayer coating of claim 16 wherein the thickness of said silver layer is between 5 nm and 100 nm.

19. A method of producing a multilayer reflective coating comprising the steps of:
(a) depositing a layer of aluminum onto a substrate;
(b) oxidizing or nitriding the deposited layer of aluminum;
(c) depositing a layer of silver over the oxidized or nitrided layer of aluminum; and
(d) depositing a capping layer over the deposited layer of silver.

20. A method of producing a multilayer reflective coating comprising the steps of:
(a) depositing a layer of aluminum onto a substrate;
(b) depositing a barrier layer over the deposited layer of aluminum; and
(c) depositing a layer of silver over the barrier layer,
wherein the barrier layer is formed from material that substantially inhibits interdiffusion between the aluminum and silver layers.

21. A method of making a reflective coating by thin film deposition of multiple materials on a substrate wherein the only materials deposited include silver and aluminum.

22. The method of claim 21 wherein aluminum is deposited and oxidized or nitrided and then silver is deposited onto the oxidized or nitrided aluminum.

23. An apparatus comprising:
a substrate having a surface; and
a multilayer coating on said surface, said coating comprising layers of aluminum and silver separated by a barrier layer formed from a material that substantially inhibits interdiffusion of the aluminum and silver.

24. The apparatus of claim 23 wherein said coating further comprises a capping layer over the silver layer.

25. The apparatus of claim 23 wherein said barrier layer is formed from one or more materials selected from the group consisting of nitrides, oxides and oxynitrides.

26. The apparatus of claim 25 wherein said barrier layer is formed from one or more materials selected from the group consisting of: aluminum nitride, silicon nitride, aluminum oxynitride, silicon oxynitride, aluminum silicon nitride, aluminum silicon oxynitride, and titanium dioxide.

27. The apparatus of claim 23 wherein said aluminum layer is formed on a surface of said substrate.

28. The apparatus of claim 23 wherein said silver layer is formed on a surface of the substrate.

29. The apparatus of claim 23 wherein the coating further comprises one or more oxide or nitride layers on a surface of said silver layer opposite said barrier layer.

30. The apparatus of claim 23 forming a reflective mirror, a solar reflector, a collector, a concentrator, a parabolic solar mirror, a planar solar mirror, a curved solar mirror, a parabolic aluminized reflector, a bulged reflector, an elliptical reflector, a blown parabolic reflector, or a multifaceted reflector.

31. A reflector comprising a substrate and a multilayer coating on said substrate, said coating comprising layers of aluminum and silver wherein said silver layer is formed closer to the surface of said substrate than said aluminum layer.

32. The reflector of claim 31 wherein said silver layer is formed on the surface of said substrate.

33. The reflector of claim 31 further comprising a barrier layer separating said layer of aluminum and silver, said barrier layer formed from a material that substantially inhibits interdiffusion of the aluminum and silver.

34. The reflector of claim 33 wherein said barrier layer is formed from one or more materials selected from the group consisting of nitrides, oxides and oxynitrides.

35. The reflector of claim 34 wherein said barrier layer is formed from one or more materials selected from the group consisting of: aluminum nitride, silicon nitride, aluminum oxynitride, silicon oxynitride, aluminum silicon nitride, aluminum silicon oxynitride, and titanium dioxide.

36. A reflector comprising:
a substrate having a surface; and
a multilayer coating formed on at least a portion of said substrate surface, said coating comprising:
a layer of aluminum overlying at least a portion of said substrate surface, said aluminum layer having a substantially uniform thickness between 5 nm and 500 nm,
a barrier layer overlying at least a portion of said aluminum layer, said barrier layer having a substantially uniform thickness less than 30 nm,
a layer of silver overlying at least a portion of said barrier layer, said silver layer having a substantially uniform thickness between 5 nm and 120 nm, and
a capping layer overlying at least a portion of said silver layer, said capping layer having a substantially uniform thickness greater than 1 nm.

37. The reflector of claim 36 wherein the barrier layer is formed from one or more materials selected from the group consisting of: aluminum nitride, silicon nitride, aluminum oxynitride, silicon oxynitride, aluminum silicon nitride, aluminum silicon oxynitride, and titanium dioxide.

38. The reflector of claim 36 where the capping layer is formed from one or more materials from the group consisting of: metals, oxides, and nitrides.

39. The reflector of claim 36 wherein the thickness of said multilayer coating is less than 300 nm.

40. The reflector of claim 36 having a reflectivity at 450 nm of at least 95 percent.

41. The reflector of claim 36 wherein said at least a portion of said substrate surface is curved.

42. The reflector of claim 36 wherein said at least a portion of said substrate surface is concave.

43. The reflector of claim 36 wherein said at least a portion of said substrate surface is faceted.

44. A lamp comprising:
a housing;
a light source within said housing;
a reflective surface covering a portion of an interior surface of the housing, said reflective surface comprising a multilayer coating having layers of aluminum and silver separated by a barrier layer formed from a material that substantially inhibits interdiffusion of the aluminum and silver.

45. The lamp of claim 44 wherein said coating further includes a capping layer over the silver layer.
